(19) United States
(12) Patent Application Publication
(10) Pub. No.: US 2014/0175119 A1
(43) Pub. Date: Jun. 26, 2014

(54) AUTOMATIC VENDING MACHINE WITH SWITCH MODULE

(71) Applicants: Hon Hai Precision Industry Co., Ltd., New Taipei (TW); Hong Fu Jin Precision Industry (WuHan) Co., Ltd., Wuhan (CN)

(72) Inventors: YUN-LUNG CHEN, New Taipei (TW); GANG SU, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 13/966,488

(22) Filed: Aug. 14, 2013

(30) Foreign Application Priority Data
Dec. 22, 2012 (CN) 2012105616557

(51) Int. Cl. G07F 9/10

(52) U.S. Cl. CPC G07F 9/10
USPC 221/282

(57) ABSTRACT

An automatic vending machine includes a chassis and a switch module. The chassis includes a bottom plate. The bottom plate defines four latching holes, and a protrusion being located on the bottom plate. The installation bracket includes an installation board, four latching tabs and a knob. The four latching tabs and the knob are located on the installation board. Each of the four latching tabs is engaged in each of the four latching holes, to prevent the switch module from moving along a first direction, and the knob is engaged with the protrusion, to prevent to the switch module from moving along a second direction opposite to the first direction so that the switch module is assembled to the chassis without screws.

### BACKGROUND

1. Technical Field

The present disclosure relates to automatic vending machines, and more particularly to an automatic vending machine with a switch module.

2. Description of Related Art

In an automatic vending machine, the vending machine includes a chassis for stocking products, and a switch module used to monitor if there are products in the chassis. Usually, the switch module is secured to the chassis with screws. Assembly or disassembly of the switch module is very time-consuming and inconvenient. Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric, cutaway view of an embodiment of an automatic vending machine.

FIG. 2 is an isometric of an installation bracket of the automatic vending machine of FIG. 1.

FIG. 3 is a partially assembled view of the automatic vending machine of FIG. 1.

FIG. 4 is similar to FIG. 3, but viewed from a different aspect.

FIG. 5 is an assembled view of the automatic vending machine of FIG. 1.

FIG. 6 is a cross-sectional view of the automatic vending machine taken along a line VI-VI of FIG. 5.

FIG. 7 is a cross-sectional view of the automatic vending machine taken along a line VII-VII of FIG. 5.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

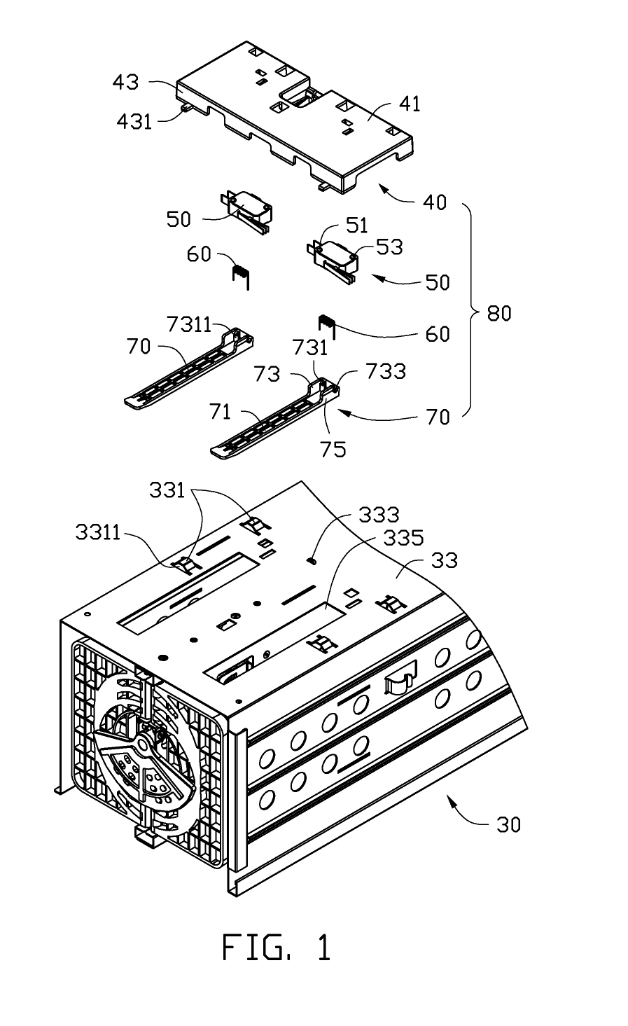

FIG. 1 illustrates an embodiment of an automatic vending machine which includes a chassis 30 and a switch module 80 attached to the chassis 30.

The chassis 30 defines two channels 31 for receiving products (not shown) and includes a bottom plate 33. The products may be, for example, tinned drinks. Four blocking pieces 331 are located on the bottom plate 33, and a latching hole 3311 is defined between each of the four blocking pieces 331 and the bottom plate 33 corresponding to the switch module 331. In one embodiment, the four blocking pieces 331 are arranged at the four corners of a rectangle. A protrusion 333 is located on the bottom plate 33 and arranged at a center of a long edge of the rectangle. Two openings 335 are defined in the bottom plate 33.

The switch module 80 includes an installation bracket 40, two switches 50, two resilient members 60 and two touching rods 70. Each of the touching rods 70 is received in an opening 335, and the two switches 50 and the two touching rods 70 cooperatively control each of the two channels 31.

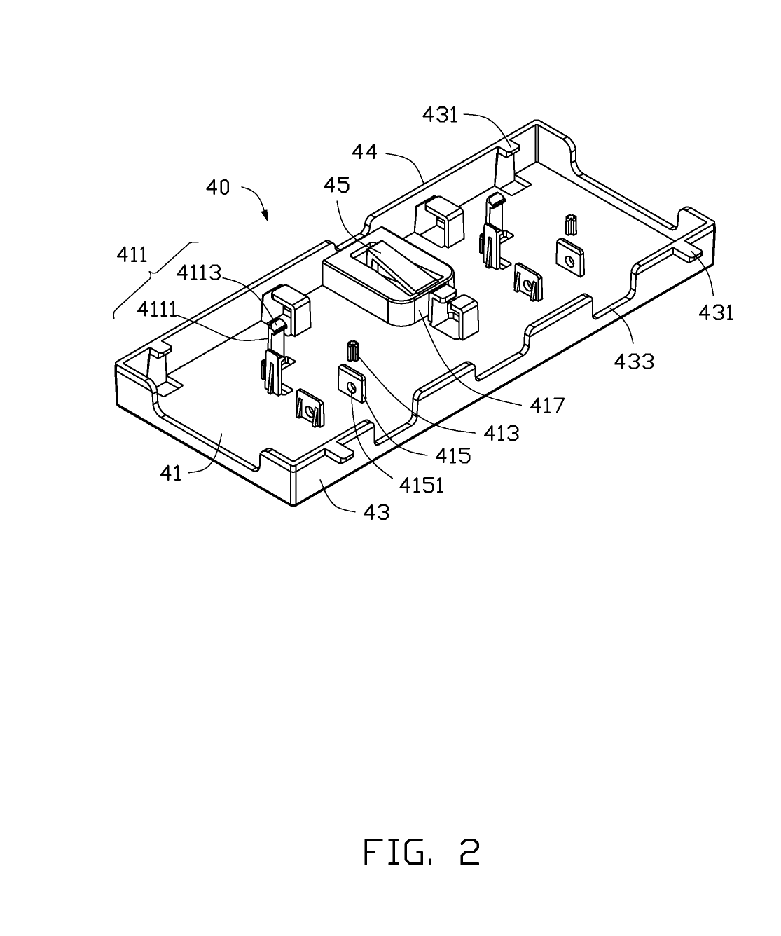

FIG. 2 shows that the installation bracket 40 includes an installation board 41, a first flange 43 and a second flange 44. The installation board 41 is substantially rectangular and has two hooks 411 and two positioning posts 413 corresponding to each of the two switches 50. The two hooks 411 are arranged at adjacent sides of a rectangle, and the two positioning post 413 are positioned on corners of the rectangle which are diagonally opposite. Each of the two hooks 411 includes a connecting portion 4111 and a blocking tab 4113 connected to a distal end of the connecting portion 4111. Two securing pieces 415 extend from the installation board 41, corresponding to each of the two touching rods 70. The two securing pieces 415 are parallel to each other and adjacent to one of the two hooks 411 and the positioning post 413. Additionally, each of the two securing pieces 415 defines a securing hole 4151 corresponding to each of the two touching rods 70.

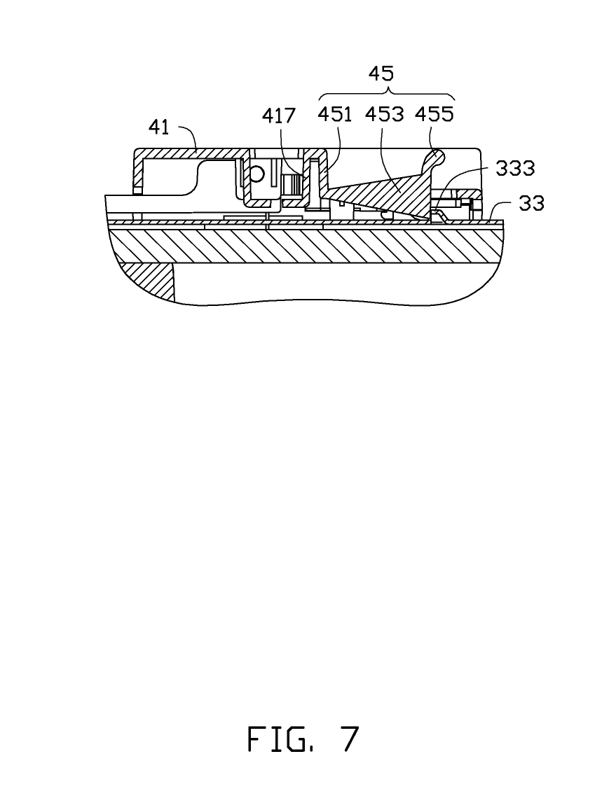

FIG. 7 shows that a blocking wall 417 is integrated with the installation board 41, positioned on a center of the installation board 41. A knob 45 is located on the installation board 41 and includes a resilient piece 451, a resisting portion 453, and an actuating tab 455. The resilient piece 451 is located on the blocking wall 417 and is resiliently deformable toward the resilient piece 451. The resisting portion 453 extends from a distal end of the resilient piece 451 and has a tapered cross-section, corresponding to the protrusion 333 of the chassis 30. The actuating tab 455 extends from a top corner of the resisting portion 453.

FIG. 2 shows that the first flange 43 and the second flange 44 extend from opposite edges of the installation board 41. Two latching tabs 431 extend from each of the first flange 43 and the second flange 44, and each latching tab 431 has a same extension direction. In one embodiment, the first flange 43 and the second flange 44 are parallel to each other and perpendicular to the installation board 41, and the two securing holes 4151 of the securing pieces 415 are perpendicular to the first flange 43 and the second flange 44. The first flange 43 defines a cutout 433 corresponding to each of the two touching rods 70.

FIG. 1 shows that each of the two switches 50 has a rectangular cross-section and defines a first receiving hole 51 and a second receiving hole 53. The first receiving hole 51 and the second receiving hole 53 are arranged at diagonally-opposite corners of a rectangle.

Each of the two touching rods 70 includes an elongated rod body 71, a first rotating tab 73, and a second rotating tab 75. The first rotating tab 73 and the second rotating tab 75 extend from two opposite sides of the rod body 71 and are arranged at one end of the rod body 71. A clipping post 731 extends from an inner side of each of the first rotating tab 73 and the second rotating tab 75, corresponding to each of the two resilient members 60. A rotating post 733 extends from an outer side of each of the first rotating tab 73 and the second rotating tab 75, to be received in the securing hole 4151. An aperture 7311 is defined in the first rotating tab 73 and maintained below the clipping post 731, for receiving a tang of each of the two resilient members 60. Another tang of each of the two resilient members 60 abuts the rod body 71.

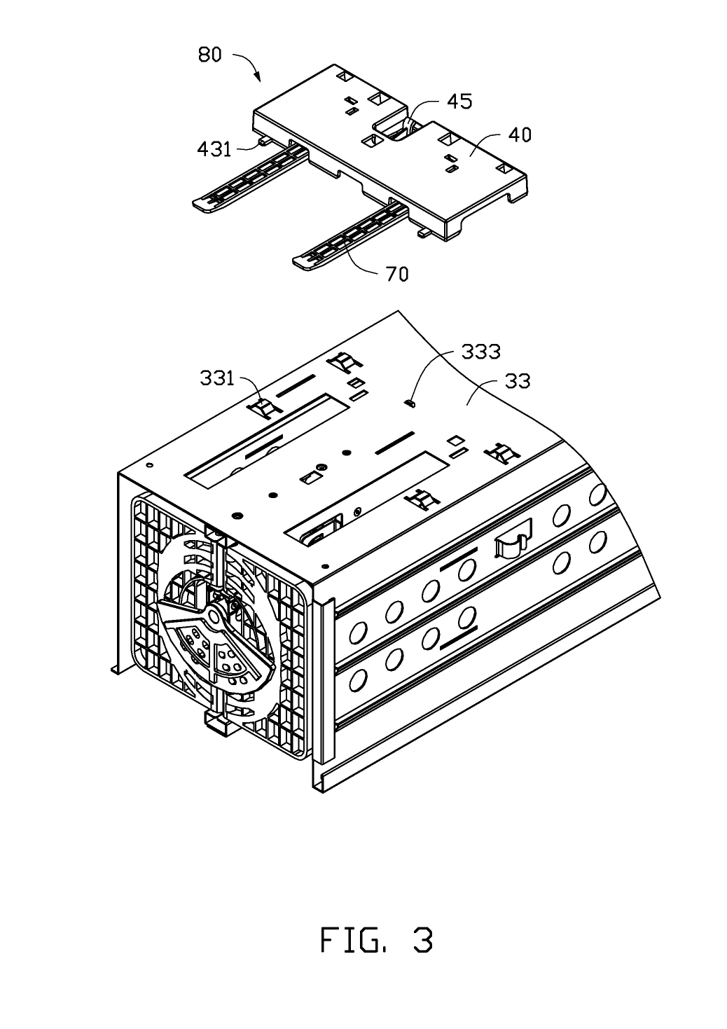

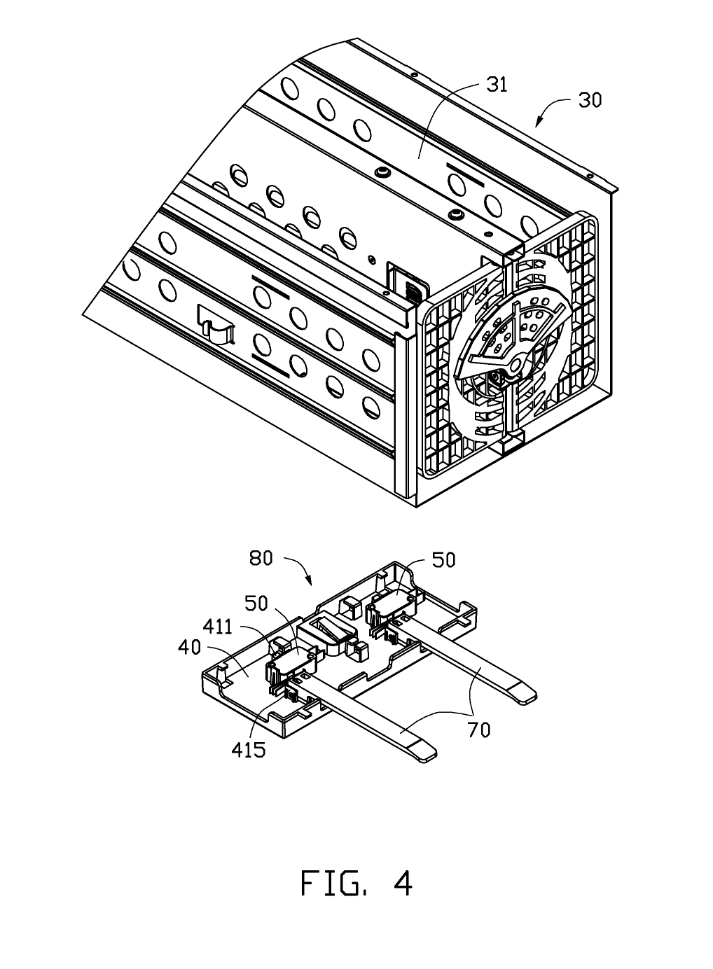

FIGS. 3 and 4 illustrate that, in assembly of one of the two switches 50 in one embodiment, the two hooks 411 are pulled outwardly, until a positioning post 413 of the installation bracket 40 is received in the first receiving hole 51 and in the second receiving hole 53 of the switch 50, to position the switch 50 on the installation bracket 40. The two hooks 411 are released, and the connecting portion 4111 of the two hooks 411 resiliently rebound to engage the blocking tab 4113 with the switch 50, to prevent the switch 50 from disengaging from the installation bracket 40.

Each of the two touching rods 70 is rotatably assembled to the installation bracket 40 by each rotating post 733 being inserted into each two securing holes 4151 of the securing pieces 415.

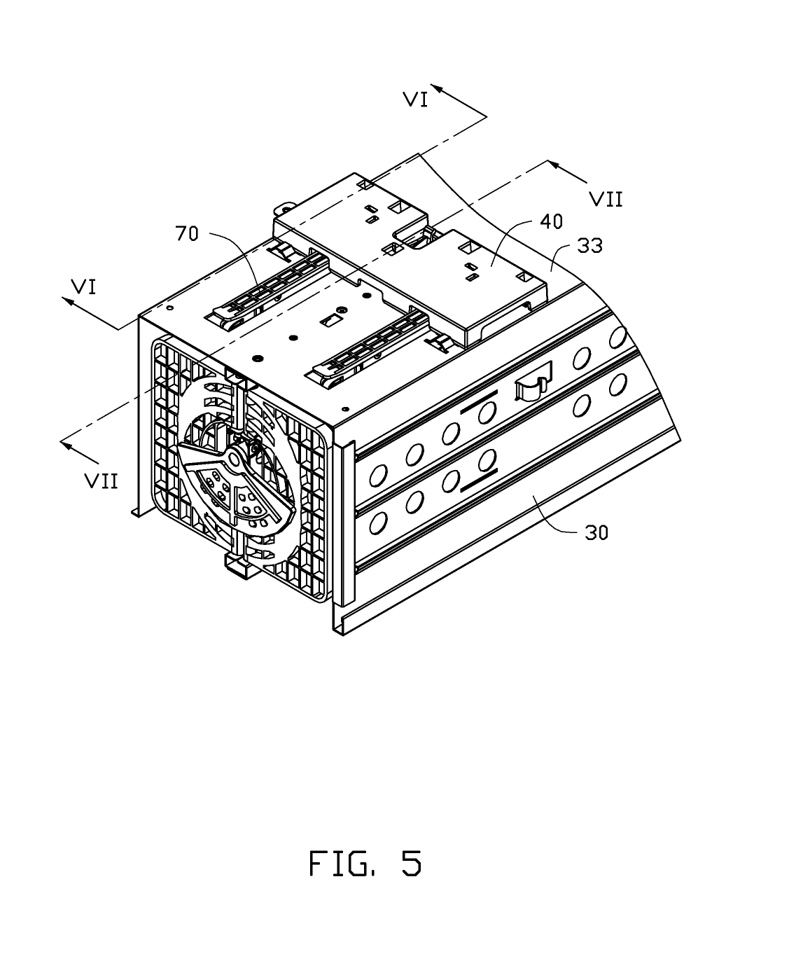

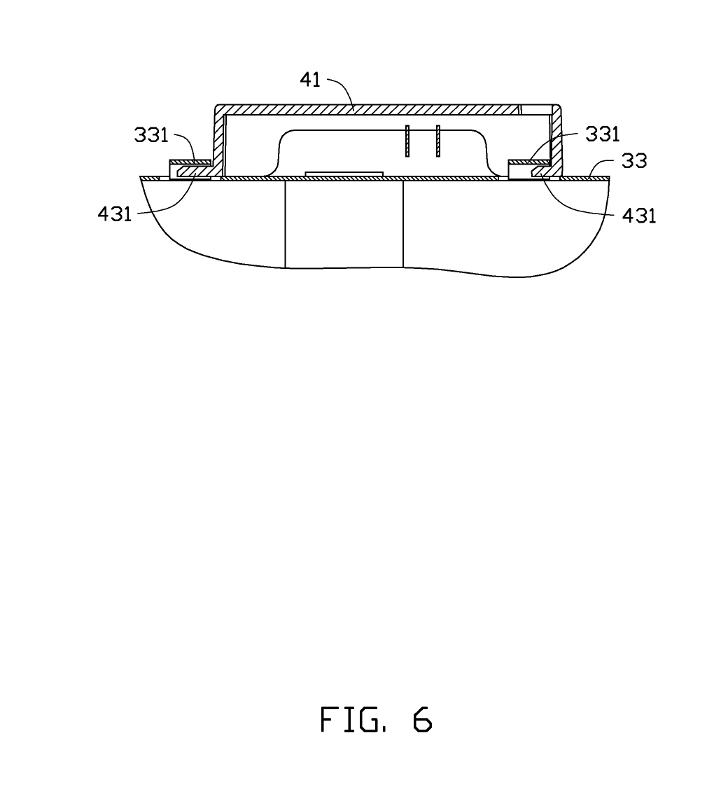

FIGS. 5-7 show that, in assembly of the switch module 80, the knob 45 is pushed, and each latch tab 431 is inserted into each latching hole 3311 along a first direction. The knob 45 is released, and the resilient piece 451 resiliently rebounds to engage the resisting portion 453 with the protrusion 333, to prevent the switch module 80 from moving along a second direction opposite to the first direction. Each of the two touching rods 70 is aligned with each of the two openings 335.

In disassembly of the switch module 80, the actuating tab 455 is pushed, and the resilient piece 451 is resiliently deformed to disengage the resisting portion 453 from the protrusion 333. The switch module 80 is detached easily along the second direction.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. An automatic vending machine comprising:
a chassis comprising a bottom plate, the bottom plate defines four latching holes, and a protrusion being located on the bottom plate; and
a switch module comprising an installation bracket, and the installation bracket comprising an installation board, four latching tabs and a knob; the four latching tabs extending from the installation board, and the knob is located on the installation board; each of the four latching tabs being engaged in each of the four latching holes, to prevent the switch module from moving along a first direction; and the knob being engaged with the protrusion, to prevent the switch module from moving along a second direction opposite to the first direction.

2. The automatic vending machine of claim 1, wherein the knob comprises a resilient piece, and a resisting portion is connected to the resilient piece; the resisting portion abuts the protrusion, and the resilient piece is resiliently deformable to disengage the resisting portion from the protrusion.

3. The automatic vending machine of claim 2, wherein a blocking wall is integrated with the installation board; and the resilient piece extends from the blocking wall and is resiliently deformable towards the blocking wall.

4. The automatic vending machine of claim 1, wherein the installation bracket further comprises a first flange and a second flange, connected to the installation board; and two of the four latching tabs extend from the first flange, and the other two of the four latching tabs extend from the second flange.

5. The automatic vending machine of claim 4, wherein four blocking pieces are located on the bottom plate; and each of the four latching holes is defined between each of the four blocking pieces and the bottom plate.

6. The automatic vending machine of claim 5, wherein the four latching tabs are arranged at four corners of a first rectangular area; and the four blocking pieces are arranged at four corners of a second rectangular area.

7. The automatic vending machine of claim 1, wherein each of the four latching tabs has an extension direction; and the extension direction of the four latching tabs has a same direction.

8. The automatic vending machine of claim 1, wherein the switch module further comprises a switch; the switch defines a first receiving hole and a second receiving hole, and two positioning posts are located on the installation board; and each of the two positioning posts is received in each of the first receiving hole and the second receiving hole, to position the switch on the installation board.

9. The automatic vending machine of claim 8, wherein two hooks are located on the installation board; and the two hooks are engaged with the switch, to prevent the switch from disengaging from the installation board.

10. The automatic vending machine of claim 9, wherein the two hooks are arranged at two adjacent sides of a rectangle; and the two positioning posts are in a diagonal line of the rectangle.

11. An automatic vending machine comprising:
a chassis comprising a bottom plate, four blocking pieces being located on the bottom plate, and a protrusion being located on the bottom plate; and
a switch module comprising an installation bracket, and the installation bracket comprising an installation board, four latching tabs and a knob; the four latching tabs extending from the installation board, the knob being located on the installation board; each of the four latching tabs being engaged with each of the four blocking pieces, to prevent the switch module from moving along a first direction; and the knob is engaged with the protrusion, to prevent the switch module from moving along a second direction opposite to the first direction.

12. The automatic vending machine of claim 11, wherein a latching hole is defined between each of the four blocking pieces and the installation board; and each of the latching tabs is engaged in the latching hole of each of the four blocking pieces.

13. The automatic vending machine of claim 11, wherein the knob comprises a resilient piece, a resisting portion connected to the resilient piece; the resisting portion abuts the protrusion, and the resilient piece is resiliently deformable to disengage the resisting portion from the protrusion.

14. The automatic vending machine of claim 13, wherein a blocking wall is integrated with the installation board; and the resilient piece extends from the blocking wall and resiliently deformable towards the blocking wall.

15. The automatic vending machine of claim 11, wherein the installation bracket further comprises a first flange and a second flange connected to the installation board; two of the four latching tabs extend from the first flange, and another two of the four latching tabs extend from the second flange.

16. The automatic vending machine of claim 11, wherein the four latching tabs are arranged at four corners of a first rectangular area; and the four blocking pieces are arranged at four corners of a second rectangular area.

17. The automatic vending machine of claim 11, wherein each of the four latching tabs has an extension direction; and the extension direction of the four latching tabs has a same direction.

18. The automatic vending machine of claim 11, wherein the switch module further comprises a switch, the switch defines a first receiving hole and a second receiving hole; two positioning posts are located on the installation board, and each of the two positioning posts is received in each of the first receiving hole and the second receiving hole, to position the switch on the installation board.

19. The automatic vending machine of claim 18, wherein two hooks are located on the installation board; and the two hooks are engaged with the switch, to prevent the switch from disengaging from the installation board.

20. The automatic vending machine of claim 19, wherein the two hooks are arranged at two adjacent sides of a rectangle; and the two positioning posts are in a diagonal line of the rectangle.
